(19) United States
(12) Patent Application Publication
(10) Pub. No.: US 2008/0087780 A1
(43) Pub. Date: Apr. 17, 2008

(54) Hinge Reinforcement For A Motor Vehicle Door Hinge

(75) Inventor: Matthias Patzold, Creteil Cedex (FR)

Correspondence Address: OSHA LIANG L.L.P., 1221 MCKINNEY STREET, SUITE 2800, HOUSTON, TX, 77010, US

(73) Assignee: Valeo Sicherheitssysteme GmbH, Erdweg (DE)

(21) Appl. No.: 11/662,123

(22) PCT Filed: Sep. 6, 2005
(86) PCT No.: PCT/EP05/54377

§ 371 Date: Mar. 7, 2007

(30) Foreign Application Priority Data
Sep. 9, 2004 (DE) 10 2004 043 561.8

(51) Int. Cl. E05D 11/00

(52) U.S. Cl. 248/213.1

(57) ABSTRACT

The invention relates to a hinge reinforcement for a motor vehicle door hinge (1) particularly for pivotally fastening a tailgate in which a fastening device (2) supporting the hinge pin (5) and being able to be joined to the body (3) of the corresponding motor vehicle, and a hinge bracket (6) that can be joined to the vehicle door (7) are provided. The hinge bracket (6), on its side facing the hinge pin(5), has two interspaced bearing arms (9) that can pivot around the hinge pin (5). The aim of the invention is to be able to use cost-effective standard hinges (1) even in automatically operable vehicle doors (7) without having to provide special measures an the body (3) of the corresponding vehicle. To this end, the invention provides that the hinge reinforcement (10) is designed in such a manner that it has, at least in partial areas, a shape corresponding to the bracket-like shape of the hinge bracket (6) whereby being able to be joined to the hinge bracket (6) in a positive manner. The first end (11) of the hinge reinforcement (10) facing the hinge pin (5) is provided with a fork-like shape so that it can be placed against the hinge pin (5) from below between the bearing arms (9) of the hinge bracket (6) whereby being supported against the hinge pin. In addition, the hinge reinforcement (10), on its side facing the hinge bracket (6), supports, in the area of the hinge bracket (6), a cam (12) that positively engages from above into a recess (13) of the hinge bracket (6) whereby preventing the hinge reinforcement (10) from falling out and pre-positioning it when the hinge reinforcement (10), after attaching to the hinge pin (5) is pivoted around the hinge pin (5) toward the hinge bracket (6). The fastening end introduction of forces ensue via a fastening element (8) between the hinge (1) and the vehicle door (7).

The invention relates to a hinge reinforcement for a motor vehicle door hinge, in particular for pivotably fastening a tailgate, in which are provided a fastening device, which supports the hinge pin and can be connected to the body of the corresponding motor vehicle, and a hinge bracket which can be connected to the vehicle door, with the hinge bracket having, on its side facing toward the hinge pin, two bearing arms which are pivotable about the hinge pin and are spaced apart from one another.

In particular in motor vehicles having a drive, which is fastened to the tailgate, for automatically actuating the tailgate, it is necessary for the hinges to withstand higher loads than comparable standard hinges for tailgates without drives of said type. It has therefore already been proposed to replace the conventional standard hinges with higher-strength forged hinges or with hinges with larger cross sections.

A disadvantage of solutions of said type is inter alia that they require relatively expensive measures. In addition, said hinges must, on account of their installation size and the possible different outward-rotating behaviors, be taken into consideration already during the development of the vehicle.

It is already known from JP 06344774 A and JP 10203170 A to provide stiffening in the region of the hinge fastening to the body in order to withstand higher loads of tailgate hinges. Said measures must likewise be taken into consideration already during the assembly of the body.

The invention is based on the object of disclosing a hinge reinforcement which makes it possible for cost-effective standard hinges to be used even for automatically actuated vehicle doors without expensive measures having to be provided on the vehicle body for this purpose.

Said object is achieved according to the invention by the features of claim 1. Further, particularly advantageous embodiments of the invention are disclosed in the subclaims.

The invention is based substantially on the concept of designing the hinge reinforcement in such a way that it has, at least in partial regions, a form corresponding to the bracket-shaped form of the hinge bracket, and can be connected in a form-fitting manner to the hinge bracket in said regions. Here, that end of the hinge reinforcement which faces toward the hinge pin is of fork-shaped design, in such a way that the first end can be plugged from below onto the hinge pin between the bearing arms of the hinge bracket and is supported on said hinge pin. In addition, the hinge reinforcement supports, on its side facing toward the hinge bracket, and in the region of the hinge pin, a cam which engages in a form-fitting manner from above into a recess of the hinge bracket in such a way as to prevent the hinge reinforcement from falling out and pre-positioning the latter. The fastening of the hinge reinforcement to the hinge bracket and the introduction of force into the hinge reinforcement takes place by means of a fastening screw which connects the respective hinge to the vehicle door.

The hinge reinforcement according to the invention can be plugged onto the hinge pin before or after the assembly of the vehicle door with the hinge, without modifications or dismounting of the hinge being necessary for this purpose. In addition, the installation space and rotational angle need not be restricted. It is necessary only for the hinge bracket to have a bore into which the cam of the hinge reinforcement engages when used as intended.

Further details and advantages of the invention can be gathered from the following exemplary embodiments which are explained on the basis of figures, in which:

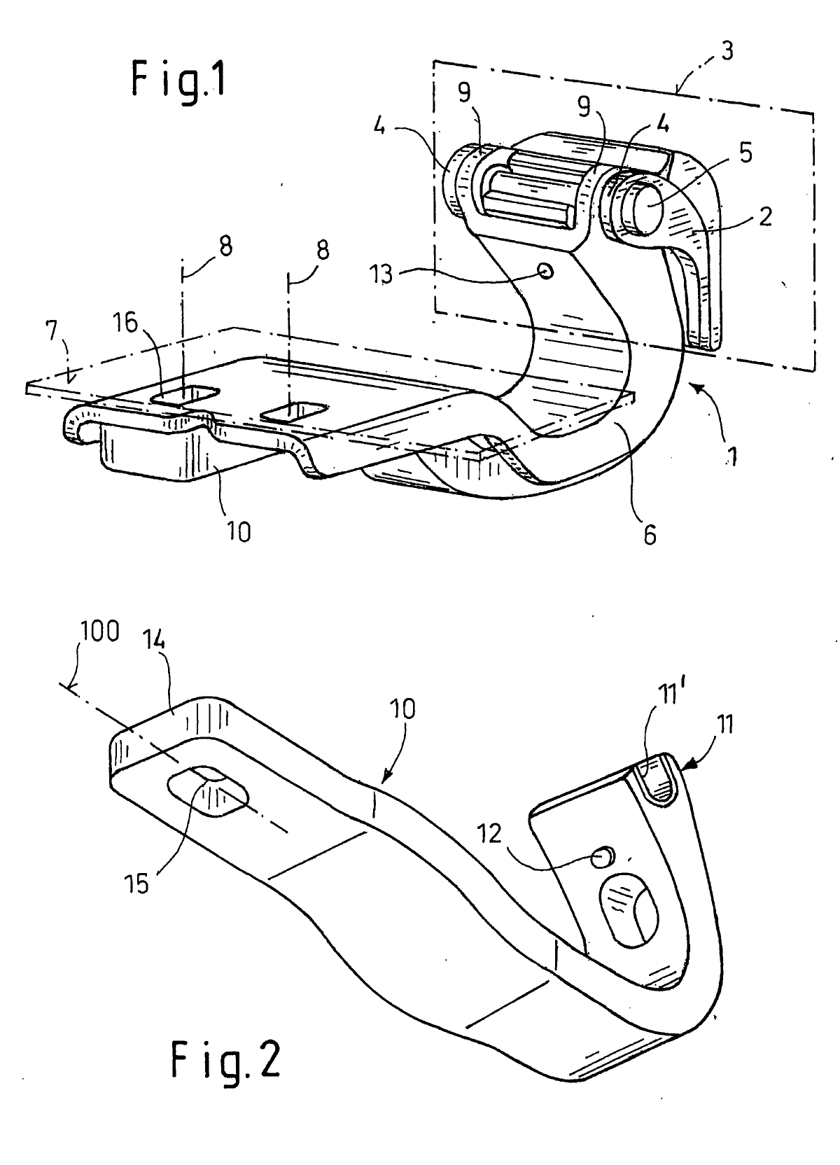

FIG. 1 shows a perspective view of a tailgate hinge, as is known per se, having a hinge reinforcement according to the invention fastened thereto;

FIG. 2 shows a perspective view of the hinge reinforcement illustrated in FIG. 1.

In FIG. 1, an outward-rotating tailgate hinge, as is known per se (standard hinge), for a motor vehicle is denoted by 1. The tailgate hinge 1 comprises a fastening device 2 for connecting the hinge 1 to the body 3 (indicated by dashed lines) of the vehicle. The fastening device 2 has two bearing arms 4 which support a hinge pin 5. In addition, the tailgate hinge 1 has a hinge bracket 6 which is pivotable about the hinge pin 5 and to which a tailgate 7 (likewise only indicated by dashed lines), which supports the drive (not illustrated) for actuating the tailgate, is connected by means of two fastening screws 8 (indicated as dash-dotted lines). The hinge bracket 6 supports, on its side facing toward the hinge pin 5, two bearing arms 9 which surround the hinge pin 5.

According to the invention, a steel hinge reinforcement 10 is provided below the hinge bracket 6, which hinge reinforcement 10, despite being of narrower design than the hinge bracket 6, however has, in the direction of its longitudinal axis 100, a bracket-shaped form which corresponds to the hinge bracket 6. In this way, the hinge reinforcement 10, when used as intended, bears in a form-fitting manner against the hinge bracket 6 at least in partial regions. In addition, the hinge reinforcement 10 is of fork-shaped design at its first end 11, which faces toward the hinge pin 5, in such a way that the first end 11 can be plugged from below onto the hinge pin 5 between the bearing arms 9 of the hinge bracket 6 and is supported on said hinge pin 5. The fork-shaped end 11, which is embodied as a bearing, is preferably lined with a Teflon-coated tinplate part 11′.

In addition, the hinge reinforcement 10 supports, on its side facing toward the hinge bracket 6, and in the upper curved region, a cam 12 which engages in a form-fitting manner from above into a corresponding recess 13 of the hinge bracket 6, so as to prevent the hinge reinforcement 10 from falling out and pre-positioning the latter, when the hinge reinforcement 10 is pivoted about the hinge pin 5 toward the hinge bracket 6 after having been plugged onto the hinge pin 5.

The hinge reinforcement 10 is connected at its second end 14, which faces away from the hinge pin 5, to the hinge bracket 6 by means of one of the two fastening screws 8 and has an opening 15, which is aligned with a corresponding opening 16 of the hinge bracket 6, for passing through the fastening screw 8.

Since only one of the two fastening screws 8 must be connected to the hinge reinforcement 10, the assembly of the hinge reinforcement does not have any influence on the previously aligned tailgate.

The invention is of course not restricted to the above-described exemplary embodiment. The hinge reinforcement can for example also have a width which corresponds approximately to the width of the hinge bracket. In addition, a light metal or a light metal alloy can also be used as the material for the hinge reinforcement.

### REFERENCE SYMBOLS

1 Motor vehicle door hinge, tailgate hinge, hinge

2 Fastening device

3 Body

4 Bearing arm

5 Hinge pin

6 Hinge bracket

7 Vehicle door, tailgate

8 Fastening screw, fastening element

9 Bearing arm

10 Hinge reinforcement

11 (First) end

11′ Tinplate part

12 Cam

13 Recess

14 (Second) end

15, 16 Openings

100 Longitudinal axis

1. A hinge reinforcement for a motor vehicle door hinge, in particular for pivotably fastening a tailgate, in which are provided a fastening device, which supports the hinge pin and can be connected to the body of the corresponding motor vehicle, and a hinge bracket which can be connected to the vehicle door, with the hinge bracket having, on its side facing toward the hinge pin, two bearing arms which are pivotable about the hinge pin and are spaced apart from one another, having the features:
a) the hinge reinforcement can be fastened to the hinge bracket and has a bracket-shaped form which corresponds to the hinge bracket;
b) the hinge reinforcement is of fork-shaped design at its first end, which faces toward the hinge pin, in such a way that the first end can be plugged from below onto the hinge pin between the bearing arms of the hinge bracket and is supported on said hinge pin;
c) the hinge reinforcement supports, on its side facing toward the hinge bracket, and in the region of the hinge pin, a cam which engages in a form-fitting manner from above into a recess of the hinge bracket in such a way as to prevent the hinge reinforcement from falling out and simultaneously pre-positioning the latter, and
d) the hinge reinforcement can be connected at its second end, which faces away from the hinge pin, to the hinge bracket by means of a fastening element.

2. The hinge reinforcement as claimed in claim 1, characterized in that the hinge reinforcement is composed of steel, a light metal or a light metal alloy.

3. The hinge reinforcement as claimed in claim 1, characterized in that the fastening element, by means of which the hinge reinforcement can be fastened to the hinge bracket, simultaneously serves as one of the fastening elements for fastening the vehicle door to the hinge bracket.

4. The hinge reinforcement according to claim 1, characterized in that the fork-shaped end, which is embodied as a bearing, of the hinge reinforcement is lined with a Teflon-coated tinplate party.

5. The hinge reinforcement as claimed in claim 2, characterized in that the fastening element, by means of which the hinge reinforcement can be fastened to the hinge bracket, simultaneously serves as one of the fastening elements for fastening the vehicle door to the hinge bracket.

6. The hinge reinforcement according to claim 2, characterized in that the fork-shaped end, which is embodied as a bearing, of the hinge reinforcement is lined with a Teflon-coated tinplate part.

7. The hinge reinforcement according to claim 3, characterized in that the fork-shaped end, which is embodied as a bearing, of the hinge reinforcement is lined with a Teflon-coated tinplate part.
